(19) United States
(12) Patent Application Publication
(10) Pub. No.: US 2008/0232319 A1
(43) Pub. Date: Sep. 25, 2008

(54) SYSTEM AND METHOD FOR TRANSMITTING/RECEIVING RESOURCE ALLOCATION INFORMATION IN A WIRELESS MOBILE COMMUNICATION SYSTEM

(75) Inventors: Yeong-Moon SON, Anyang-si (KR); Eun-Taek LIM, Suwon-si (KR); Pan-Yuh JOO, Seoul (KR); Jung-Je SON, Seongnam-si (KR); Hyoung-Kyu LIM, Seoul (KR); Sung-Jin LEE, Seoul (KR); Hyun-Jeong KANG, Seoul (KR); Jae-Hyuk JANG, Suwon-si (KR); Young-Ho KIM, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/054,073

(22) Filed: Mar. 24, 2008

(30) Foreign Application Priority Data
Mar. 23, 2007 (KR) 2007-0028909

(51) Int. Cl. H04Q 7/00; H04L 27/28

(52) U.S. Cl. 370/329; 375/299; 375/316; 375/260

(57) ABSTRACT

A system for transmitting/receiving resource allocation information in a wireless mobile communication system is provided. A transmission apparatus allocates a data burst in a frame, the data burst including a two-dimensional region of a time domain and a frequency domain, and transmits resource allocation information on the allocated data burst. A reception apparatus receives the resource allocation information from the transmission apparatus, and detects a region of the frame where the data burst is allocated, using the received resource allocation information. The resource allocation information includes information on a start point and an end point of the data burst. The start point indicates a point which is spaced apart from an start point of the frame by a first offset value in the time domain, and is spaced apart from the start point of the frame by a second offset value in the frequency domain. The end point indicates a point which is spaced apart from the start point by a third offset value in the time domain, and is spaced apart from the start point by a fourth offset value in the frequency domain. The data burst is a two-dimensional rectangular region having a diagonal line segment connecting the start point to the end point.

### PRIORITY

This application claims the benefit under 35 U.S.C. § 119(a) of a Korean patent application filed in the Korean Intellectual Property Office on Mar. 23, 2007 and assigned Serial No. 2007-28909, the entire disclosure of which is hereby incorporated by reference.

### BACKGROUND OF THE INVENTION

1. Field of the Invention

The present invention relates to a wireless mobile communication system. More particularly, the present invention relates to a system and method for transmitting/receiving resource allocation information in a wireless mobile communication system.

2. Description of the Related Art

An Institute of Electrical and Electronics Engineers (IEEE) 802.16 communication system is an example of a next generation communication system. As its name suggests, the IEEE 802.16 communication system uses the IEEE 802.16 standard.

The conventional IEEE 802.16 communication system uses an Uplink Media Access Protocol (UL-MAP) message and a Downlink Media Access Protocol (DL-MAP) message to provide UL and DL resource allocation information.

The DL-MAP message includes an Information Element (IE) defined in Table 1 below.

TABLE 1

| Syntax | Size | Notes |
|---|---|---|
| | (Omitted) | |
| OFDMA Symbol offset | 8 bits | |
| If (Permutation = 0b11 and (AMC | | |
| type is 2×3 or 1×6)) { | | |
| Subchannel offset | 8 bits | |
| Boosting | 3 bits | 000: normal (not boosted); 001: |
| | | +6 dB; 010: −6 dB; 011: +9 dB; |
| | | 100: +3 dB; 101: −3 dB; 110: −9 dB; |
| | | 111: −12 dB |
| No. OFDMA triple symbol | 5 bits | Number of OFDMA symbols is |
| | | given in multiples of 3 symbols |
| No. subchannels | 6 bits | |
| } else { | | |
| Subchannel offset | 6 bits | |
| Boosting | 3 bits | 000: normal (not boosted); 001: |
| | | +6 dB; 010: −6 dB; 011: +9 dB; |
| | | 100: +3 dB; 101: −3 dB; 110: −9 dB; |
| | | 111: −12 dB |
| No. OFDMA Symbols | 7 bits | |
| No. Subchannels | 6 bits | |
| } | | |
| | (Omitted) | |

Using the information of table 1, regions of DL resources, e.g., DL data bursts, can be determined. Specifically, the DL resources can be expressed by the values of ‘Orthogonal Frequency Division Multiple Access (OFDMA) Symbol offset’, ‘Subchannel offset’, ‘No. OFDMA Symbols’ and ‘No. Subchannels’ that are included in Table 1.

FIG. 1 is a diagram illustrating a frame structure used in a conventional wireless mobile communication system.

Referring to FIG. 1, the frame includes a DL sub-frame region and a UL sub-frame region. The DL sub-frame includes a preamble region 100 where a preamble is transmitted, a Frame Control Header (FCH) region 110 where frame control information is transmitted, a MAP region 120 where a MAP message is transmitted, and a data burst allocation region 130 where data bursts are allocated. In the frame, the horizontal axis represents the time domain and the vertical axis represents the frequency domain.

A description will be made of a conventional method for allocating data bursts in the data burst allocation region 130 of the DL sub-frame and for expressing the allocation information.

Allocation information of the allocated data bursts can be expressed using ‘OFDMA Symbol offset’, ‘Subchannel offset’, ‘No. OFDMA Symbols’ and ‘No. Subchannels’. Specifically, the point where ‘OFDMA Symbol offset’ is coincident with ‘Subchannel offset’ is a starting point of the allocated data burst. Furthermore, a two-dimensional rectangular data burst allocation region 140, which is composed of ‘No. OFDMA Symbols’ OFDMA symbols in the horizontal axis and ‘No. Subchannels’ subchannels in the vertical axis on the basis of the starting point, includes the data bursts that have been allocated.

A detailed description will now be made of four types of information used for expressing the data burst allocation information.

1. Expression of No. OFDMA Symbols

In the IEEE 802.16 communication system, the maximum number of OFDMA symbols included in one frame is 57. The ‘57’ is the sum of the allowable number of OFDMA symbols included in a DL sub-frame and the allowable number of OFDMA symbols included in a UL sub-frame. Therefore, the total number of OFDMA symbols included in the DL sub-frame should be less than 57. Thus, providing even 6 bits as the number of bits for representing positions and sizes of the DL data bursts is sufficient. The number of OFDMA symbols per frame proposed in the IEEE 802.16 communication system is as shown in Table 2 below.

TABLE 2

| | | | | BS | |
|---|---|---|---|---|---|
| Item | Description | Reference | Status | Required | BS Values |
| 1 | Number of | 8.4.4.2 | oi | Y | (35, 12), |
| | OFDM | | | | (34, 13), |
| | Symbols in DL | | | | (33, 14), |
| | and UL for 5 | | | | (32, 15), |
| | and 10 MHz | | | | (31, 16), |
| | BW | | | | (30, 17), |
| | | | | | (29, 18), |
| | | | | | (28, 19), |
| | | | | | (27, 20), |
| | | | | | (26, 21) |
| 2 | Number of | 8.4.4.2 | oi | Y | (30, 12), |
| | OFDM | | | | (29, 13), |
| | Symbols in DL | | | | (28, 14), |
| | and UL for | | | | (27, 15), |
| | 8.75 MHz BW | | | | (26, 16), |
| | | | | | (25, 17), |
| | | | | | (24, 18) |
| 3 | Number of | 8.4.4.2 | oi | Y | (24, 09), |
| | OFDM | | | | (23, 10), |
| | Symbols in DL | | | | (22, 11), |
| | and UL for 7 MHz | | | | (21, 12), |
| | BW | | | | (20, 13), |
| | | | | | (19, 14), |
| | | | | | (18, 15) |

2. Expression of No. Subchannels

The number of subchannels constituting a frame is subject to change according to the number of OFDMA subcarriers and a Fast Fourier Transform (FFT) size, as shown in Table 3.

TABLE 3

| | | # |
|---|---|---|
| | Subchannel | Subchannel |
| FFT size | group | range |
| 2048 | 0 | 0-11 |
| | 1 | 12-19 |
| | 2 | 20-31 |
| | 3 | 32-39 |
| | 4 | 40-51 |
| | 5 | 52-59 |
| 1024 | 0 | 0-5 |
| | 1 | 6-9 |
| | 2 | 10-15 |
| | 3 | 16-19 |
| | 4 | 20-25 |
| | 5 | 26-29 |
| 512 | 0 | 0-4 |
| | 1 | N/A |
| | 2 | 5-9 |
| | 3 | N/A |
| | 4 | 10-14 |
| | 5 | N/A |
| 128 | 0 | 0 |
| | 1 | N/A |
| | 2 | 1 |
| | 3 | N/A |
| | 4 | 2 |
| | 5 | N/A |

As illustrated in Table 3, when the FFT size is at its maximum of 2048 (FFT size=2048), the number of subchannels is also at a maximum of 60. Accordingly, it is possible to express the number of subchannels with a maximum of 6 bits.

In the frame of FIG. 1, the DL sub-frame and the UL sub-frame are divided into a plurality of permutation zones. The types of the permutation zones are classified into a Partial Usage of Subchannels (PUSC) zone, a Full Usage of Subchannels (FUSC) zone, an Optional FUSC zone, a Tile Usage of Subchannels (TUSC) zone, a Band Adaptive Modulation and Coding (AMC) zone, etc.

In the permutation zones, the number of subchannels and OFDMA symbols included in a DL slot is subject to change according to the permutation method used in the corresponding permutation zones, as follows. Here, the DL slot is the basic allocation unit for DL data bursts.

FUSC zone and Optional FUSC zone: 1 DL slot=1 subchannel ×1 OFDMA symbol

PUSC zone: 1 DL slot=1 subchannel ×2 OFDMA symbols

TUSC1 zone and TUSC 2 zone: 1 DL slot=1 subchannel ×3 OFDMA symbols

Band AMC zone:

$$1 DL slot \begin{matrix}= 3 subchannels \times 2 OFDMA symbols , \\ = 2 subchannels \times 3 OFDMA symbols , or \\ = 1 subchannels \times 3 OFDMA symbols\end{matrix}$$

For the Band AMC zone, 6 bins are used as the minimum unit for DL data burst allocation. In addition, 6 bins constitute one DL slot.

As described above, the number of bits necessary for expressing ‘Subchannel offset’ and ‘OFDMA Symbol offset’ is subject to change according to the FFT size and the permutation method.

3. Expression of Subchannel offset

For FFT size=2048, as the maximum number of subchannels is 60, 6 bits are needed for subchannel offset expression. However, for FFT size=128, as the maximum number of subchannels is 3, it is possible to sufficiently express the subchannel offset with 2 bits.

Even for the same FFT size, the number of bits for expressing the subchannel offset is subject to change according to the method of making the subchannel. That is, for the FUSC method, since the number of subchannels used for one DL slot is 1, 6 bits are needed to express the subchannel offset. However, for the Band AMC method, since the number of subchannels used for one DL slot is 3, 5 bits are needed to express the subchannel offset in order to indicate a maximum of 60/3=20.

### 4. Expression of OFDMA Symbol Offset

The number of bits for expressing an OFDMA symbol offset is also subject to change according to the basic OFDMA symbol offset constituting one DL slot. For example, the number of bits necessary for expressing the OFDMA symbol offset is subject to change according to the FFT size and the permutation zone. Further, even in representing sizes of the subchannel and the OFDMA symbol, it is possible to variably determine the number of necessary bits according to the permutation zone.

As described above, the number of bits required for the ‘No. OFDMA Symbols’ field, the ‘No. Subchannels’ field, the ‘Subchannel offset’ field and the ‘OFDMA Symbol offset’ field constituting the DL-MAP IE is considerable. Accordingly, this considerable amount of data causes the occurrence of signaling overhead and a reduction in system performance.

### SUMMARY OF THE INVENTION

An aspect of the present invention is to address at least the above-mentioned problems and/or disadvantages and to provide at least the advantages described below. Accordingly, an aspect of the present invention is to provide a resource allocation information transmission/reception system and method for reducing signaling overhead in a wireless mobile communication system.

According to one aspect of the present invention, a system for transmitting/receiving resource allocation information in a wireless mobile communication system is provided. The system includes a transmission apparatus for allocating a data burst in a frame wherein the data burst is a two-dimensional region in a time domain and a frequency domain, and for transmitting resource allocation information on the allocated data burst, and a reception apparatus for receiving the resource allocation information from the transmission apparatus and for detecting a region of the frame where the data burst is allocated, using the received resource allocation information. The resource allocation information includes information on a start point and an end point of the data burst. The start point comprises a point which is spaced apart from a start point of the frame by a first offset value in the time domain, and is spaced apart from the start point of the frame by a second offset value in the frequency domain. The end point indicates a point which is spaced apart from the start point by a third offset value in the time domain, and is spaced apart from the start point by a fourth offset value in the frequency domain. The data burst is a two-dimensional rectangular region having a diagonal line segment connecting the start point to the end point.

According to another aspect of the present invention, a method for transmitting resource allocation information by a transmission apparatus in a wireless mobile communication system is provided. The method includes allocating a data burst in a frame wherein the data burst is a two-dimensional region in a time domain and a frequency domain and transmitting resource allocation information on the allocated data burst. The resource allocation information includes information on a start point and an end point of the data burst. The start point indicates a point which is spaced apart from a start point of the frame by a first offset value in the time domain, and is spaced apart from the start point of the frame by a second offset value in the frequency domain. The end point indicates a point which is spaced apart from the start point by a third offset value in the time domain, and is spaced apart from the start point by a fourth offset value in the frequency domain. The data burst is a two-dimensional rectangular region having a diagonal line segment connecting the start point to the end point.

According to further another aspect of the present invention, a method for receiving resource allocation information by a reception apparatus in a wireless mobile communication system is provided. The method includes receiving resource allocation information on a data burst and detecting a region where the data burst is allocated, from a frame which is a two-dimensional region in a time domain and a frequency domain, using the received resource allocation information. The resource allocation information includes information on a start point and an end point of the data burst. The start point indicates a point which is spaced apart from an start point of the frame by a first offset value in the time domain, and is spaced apart from the start point of the frame by a second offset value in the frequency domain. The end point indicates a point which is spaced apart from the start point by a third offset value in the time domain, and is spaced apart from the start point by a fourth offset value in the frequency domain.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following description taken in conjunction with the accompanying drawings in which:

FIG. 1 is a diagram illustrating a frame structure used in a conventional wireless mobile communication system;

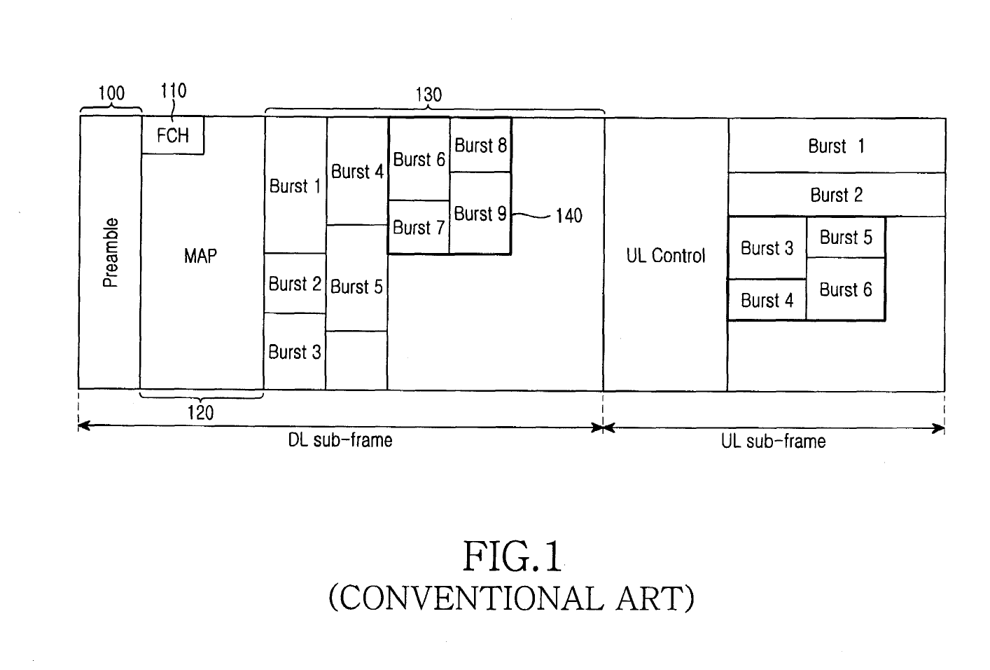

FIG. 2 is a diagram illustrating a frame structure indicating a position and a size of a data burst according to a first exemplary embodiment of the present invention;

FIG. 3 is a flowchart illustrating a process of receiving a data burst by a mobile station according to an exemplary embodiment of the present invention; and

FIG. 4 is a flowchart illustrating a process of generating a DL-MAP message by a base station according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a system and method for transmitting/receiving resource allocation information in a wireless mobile communication system. Although a description of the present invention will be made herein for a resource allocation information transmission/reception system and method in which data bursts are used as resources, this is to be understood as merely an example. That is, the resource allocation information transmission/reception system and method proposed by the present invention can be applied to any wireless mobile communication system that allocates a data burst region in a two-dimensional manner.

### First Exemplary Embodiment

An exemplary embodiment of the present invention proposes a Downlink-Media Access Protocol (DL-MAP) Information Element (IE) as shown in Table 4.

TABLE 4

| Syntax | Size | Notes |
|---|---|---|
| DL-MAP IE ( ) { | — | — |
| DIUC | 3 bits | |
| if(DIUC = = 14) { | 10 bits | |
| Extended-2 DIUC dependent IE | 2 bits | |
| } Else if(DIUC = = 15) { | 1 bit | — |
| Extended DIUC dependent IE | — | — |
| } else { | 8 bits | — |
| if(INC _CID = = 1) { | 8 bits | — |
| N_CID | — | — |
| for(n=0; n/N_CID; n++) { | | |
| If(included_in_SUB-DL-UL-MAP) { | | |
| RCID_IE( ) | | |
| } else { | | |
| CID | 16 bits | |
| } | | |
| } | | |
| } | | |
| OFDMA_Subchannel_symbol offset_1st | 12 bits | |
| OFDMA_Subchannel_symbol offset_2nd | 12 bits | |
| Boosting | | |
| Repetition Coding Indication | | |
| } | | |
| } | | |

The DL-MAP IE shown in Table 4 uses Orthogonal Frequency Division Multiple Access (OFDMA)_Subchannel_Symbol_offset_{—}1st and OFDMA_Subchannel_Symbol_offset_{—}2nd in order to represent positions and sizes of DL data bursts. The two types of information each includes 12 bits, having a total of 24 bits of information. It can be appreciated that the 24-bit information is reduced from the conventional 27-bit information used for representing positions and sizes of DL data bursts with ‘OFMDA Symbol offset’, ‘Subchannel offset’, ‘No. OFDMA Symbols’ and ‘No. Subchannels’.

Each of the OFDMA_Subchannel_Symbol_offset_{—}1st and the OFDMA_Subchannel_Symbol_offset_{—}2nd has the format shown in Table 5.

TABLE 5

| | |
|---|---|
| Subchannel Offset (6 bits) | OFDMA symbol Offset (6 bits) |

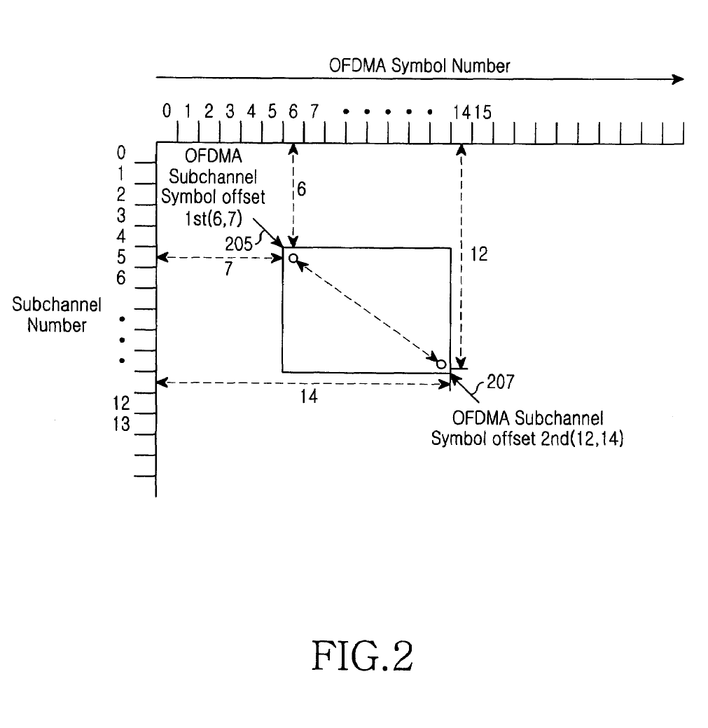

FIG. 2 is a diagram illustrating a frame structure indicating a position and a size of a data burst according to a first exemplary embodiment of the present invention.

Referring to FIG. 2, a two-dimensional rectangular data burst region, which is defined by the time (OFDMA symbols) and the frequency (subchannels) in a frame, is indicated by OFDMA Subchannel_Symbol offset 1st and OFDMA_Subchannel_Symbol_offset_{—}2nd.

The OFDMA_Subchannel_Symbol_offset_{—}1st indicates a relative position from the origin (start point) of the frame to a start point 205 of the two-dimensional rectangular data burst region. That is, the OFDMA_Subchannel_Symbol_offset_{—}1st, in accordance with Table 5, can be represented as (x1, y1), and indicates an apex 205 which is spaced apart from a start point of the frame by x1 subchannels and apart from the start point of the frame by y1 OFDMA symbols. In the case of FIG. 2, x1=6 and y1=7.

Similarly, the OFDMA_Subchannel_Symbol_offset_{—}2nd indicates a relative position from the start point 205 to an end point 207 of the two-dimensional rectangular data burst region. That is, the OFDMA_Subchannel_Symbol_offset_{—}2nd can be represented as (x2, y2), and indicates an apex 207 which is spaced apart from the start point 205 by x2 subchannels and apart from the start point 205 by y2 OFDMA symbols. In the case of FIG. 2, x2=6 and y2=7. As illustrated in FIG. 2, the data burst is a two-dimensional rectangular region having a diagonal line segment connecting the start point to the end point

Upon receiving a DL-MAP message including therein the OFDMA_Su bchannel_Symbol offset_{—}1st and the OFDMA_Subchannel_Symbol_offset_{—}2nd, a mobile station determines the start point of the region where its own data burst is allocated, based on the OFDMA_Subchannel_Symbol_offset_{—}1st. Next, the mobile station determines the end point of the region where the data burst is allocated, depending on the OFDMA_Subchannel_Symbol_offset_{—}2nd. That is, a size of the data burst allocation region is determined by subtracting an x1 value of OFDMA_Subchannel_Symbol_offset_{—}1st from an x1+x2 value of OFDMA_Subchannel_Symbol_offset_{—}2nd, and subtracting an y1 value of OFDMA_Subchannel_Symbol_offset_{—}1st from an y1+y2 value of OFDMA_Subchannel_Symbol_offset_{—}2nd.

### Second Exemplary Embodiment

The second exemplary embodiment, similar to the first exemplary embodiment, indicates a data burst allocation region using a start point and an end point of a two-dimensional data burst allocation region. However, the second exemplary embodiment can automatically determine the number of bits necessary for representing a subchannel offset and an OFDMA symbol offset between the start point and the end point according to the Fast Fourier Transform (FFT) size, the number of OFDMA symbols and the permutation method. A description will now be made of the parameters necessary for implementing the second embodiment.

1. No. OFDMA symbols: A parameter that the mobile station can determine depending on ‘No. OFDMA symbols’ or UL allocation start IE included in a DL-MAP message.

2. FFT size; Although it is a value previously agreed upon between a base station and a mobile station during system implementation, the mobile station may be able to determine another FFT size when interworking with the system having the foregoing another FFT size.

3. Max No. of Subchannels: The number of subchannels constituting a frame. Its value is determined as shown in Table 6 according to the bandwidth.

TABLE 6

| FFT size | Max_No. of_Subchannels |
|---|---|
| 128 | 3 |
| 512 | 15 |
| 1024 | 30 |
| 2048 | 60 |

4. OFDMA Symbol_allocation_unit: A basic allocation unit for OFDMA symbols based on the permutation method. Its value is determined as shown in Table 7 according to the permutation method type. The mobile station receives OFDMA DL STC DL Zone IE to recognize the permutation method type and AMC type.

TABLE 7

| Permutation | OFDMA_Symbol_allocation_unit |
|---|---|
| FUSC, Optional FUSC | 1 |
| PUSC | 2 |
| TUSC1, TUSC2 | 3 |
| Band AMC (AMC Type == 00) | 6 |
| Band AMC (AMC Type == 01) | 3 |
| Band AMC (AMC Type == 10) | 2 |

5. Subchannel_allocation_unit: A basic allocation unit for subchannels based on the permutation method. Its value is determined as shown in Table 8 according to the permutation method type. The mobile station receives OFDMA DL STC DL Zone IE to recognize permutation method type and AMC type.

TABLE 8

| Permutation | Subchannel_allocation_unit |
|---|---|
| FUSC, Optional FUSC | 1 |
| PUSC | 1 |
| TUSC1, TUSC2 | 1 |
| Band AMC (AMC type == 00) | 1 |
| Band AMC (AMC type == 01) | 2 |
| Band AMC (AMC type == 10) | 3 |

As described above, it is possible to calculate the number of bits necessary for expressing an OFDMA symbol offset and a subchannel offset for each of the OFDMA_Subchannel_Symbol_offset_{—}1st and the OFDMA_Subchannel_Symbol_offset_{—}2nd according to the parameters the permutation method type.

First, the number of bits necessary for expressing the OFDMA symbol offset in each of the OFDMA_Subchannel_Symbol_offset_{—}1st and the OFDMA_Subchannel_Symbol_offset_{—}2nd can be calculated using Equation (1).

$$No . of bits for OFDMA Symbol offset = ⌈ {log}_{2} \frac{No . OFDMA Symbols }{OFDMA Symbol allocation unit} ⌉ \qquad ( 1 )$$

Next, the number of bits necessary for expressing the subchannel offset in each of the OFDMA Subchannel_Symbol_offset 1st and the OFDMA_Subchannel_Symbol_offset_{—}2nd can be calculated using Equation (2).

$$No . of bits for OFDMA Subchannel offset = ⌈ {log}_{2} \frac{Max No . of Subchannels }{Subchannel allocation unit} ⌉ \qquad ( 2 )$$

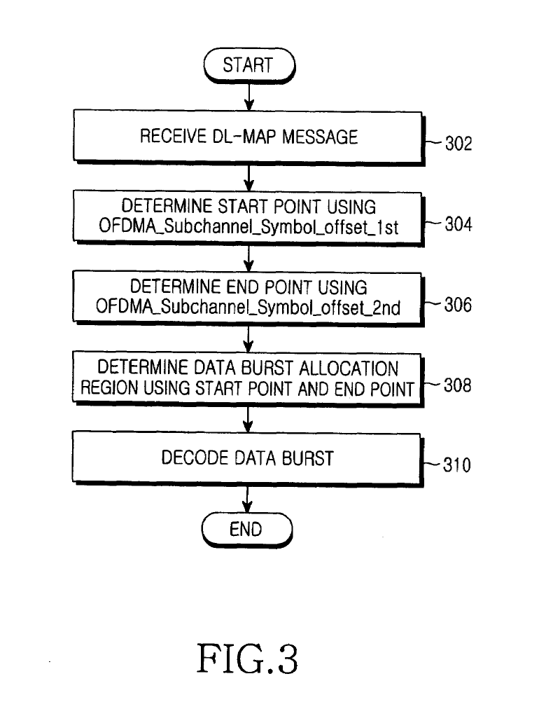

FIG. 3 is a flowchart illustrating a process of receiving a data burst by a mobile station according to an exemplary embodiment of the present invention.

Referring to FIG. 3, in step 302, the mobile station receives a DL-MAP message from a base station. The DL-MAP message includes DL-MAP IE, and the DL-MAP IE includes an OFDMA_Subchannel_Symbol_offset_{—}1st and an OFDMA_Subchannel_Symbol_offset_{—}2nd for representing a position and a size of a DL data burst.

In step 304, the mobile station determines a start point of a two-dimensional data burst allocation region depending on the OFDMA_Subchannel_Symbol_offset_{—}1st. In step 306, the mobile station determines an end point of the two-dimensional data burst allocation region depending on the OFDMA_Subchannel_Symbol_offset_{—}2nd. In step 308, the mobile station determines the two-dimensional data burst allocation region having the start point and the end point. In step 310, the mobile station decodes a data burst located in the determined burst allocation region.

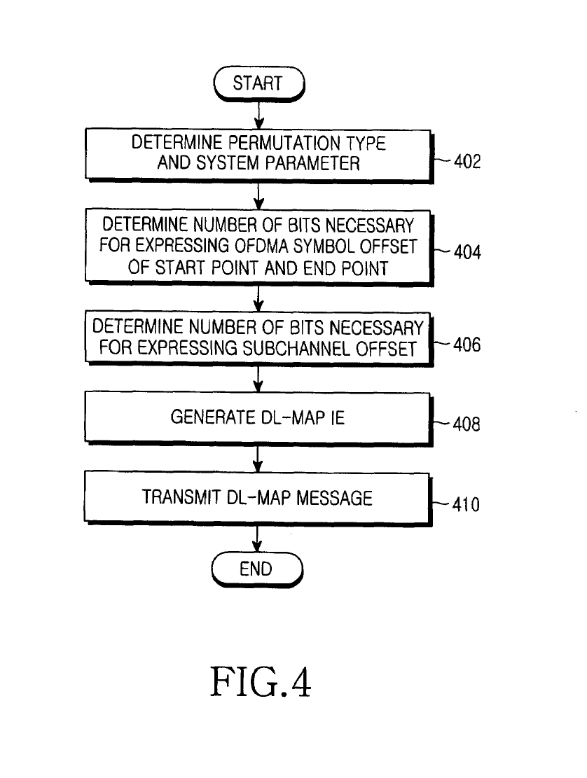

FIG. 4 is a flowchart illustrating a process of generating a DL-MAP message by a base station according to an exemplary embodiment of the present invention.

Referring to 4, in step 402, the base station determines a subchannel permutation method and system parameters. In step 404, the base station determines the number of bits necessary for expressing an OFDMA symbol offset between a start point and an end point of a two-dimensional data burst allocation region. In an exemplary implementation, the number of bits may be determined using Equation 1 above. In step 406, the base station determines the number of bits necessary for expressing a subchannel offset between the start point and the end point of the two-dimensional data burst allocation region. In an exemplary implementation, the number of bits may be determined using Equation 2 above. In step 408, the base station generates a DL-MAP IE corresponding to the calculated number of bits. In step 410, the base station transmits a DL-MAP message including the generated DL-MAP IE.

As is apparent from the foregoing description, exemplary embodiments of the present invention use a MAP message indicating two points of a two-dimensional data burst allocation region in the mobile communication system, thereby reducing the size of the MAP message and thus minimizing the signaling overhead.

While the invention has been shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for transmitting resource allocation information by a transmission apparatus in a wireless mobile communication system, the method comprising:
allocating a data burst in a frame comprising a two-dimensional region in a time domain and a frequency domain; and
transmitting resource allocation information on the allocated data burst,
wherein the resource allocation information includes information on a start point and an end point of the allocated data burst, and the start point comprises a point which is spaced apart from a start point of the frame by a first offset value in the time domain and which is spaced apart from the start point of the frame by a second offset value in the frequency domain, the end point comprises a point which is spaced apart from the start point by a third offset value in the time domain and which is spaced apart from the start point by a fourth offset value in the frequency domain, and
the data burst is a two-dimensional rectangular region having a diagonal line segment connecting the start point to the end point.

2. The method of claim 1, wherein the time domain comprises an Orthogonal Frequency Division Multiple Access (OFDMA) symbol domain and each of the first offset value and the third offset value comprise the number of OFDMA symbols.

3. The method of claim 1, wherein the frequency domain comprises a subchannel domain and each of the second offset value and the fourth offset value comprise the number of subchannels.

4. The method of claim 1, wherein the resource allocation information is transmitted using a resource allocation information message.

5. The method of claim 4, wherein the resource allocation information message comprises a Downlink MAP (DL-MAP) message.

6. The method of claim 1, wherein each of the first offset value and the third offset value is expressed with a predetermined number of bits, and the number of bits representing each of the first offset value and the third offset value is calculated depending on at least one of a subchannel permutation method used by the transmission apparatus and the total number of OFDMA symbols included in the frame.

7. The method of claim 1, wherein each of the second offset value and the fourth offset value is expressed with a predetermined number of bits, and the number of bits representing each of the second offset value and the fourth offset value is calculated depending on at least one of a subchannel permutation method used by the transmission apparatus and the total number of subchannels included in the frame.

8. A method for receiving resource allocation information by a reception apparatus in a wireless mobile communication system, the method comprising:
receiving resource allocation information on a data burst; and
detecting a region where the data burst is allocated from a frame which comprising a two-dimensional region in a time domain and a frequency domain, using the received resource allocation information,
wherein the resource allocation information includes information on a start point and an end point of the allocated data burst; wherein the start point comprises a point which is spaced apart from an start point of the frame by a first offset value in the time domain and is which spaced apart from the start point of the frame by a second offset value in the frequency domain; the end point comprises a point which is spaced apart from the start point by a third offset value in the time domain and which is spaced apart from the start point by a fourth offset value in the frequency domain, and
the data burst is a two-dimensional rectangular region having a diagonal line segment connecting the start point to the end point.

9. The method of claim 8, wherein the time domain comprises an Orthogonal Frequency Division Multiple Access (OFDMA) symbol domain, and each of the first offset value and the third offset value comprises the number of OFDMA symbols.

10. The method of claim 8, wherein the frequency domain comprises a subchannel domain, and each of the second offset value and the fourth offset value comprises the number of subchannels.

11. The method of claim 8, wherein the receiving of the resource allocation information comprises receiving a resource allocation information message.

12. The method of claim 11, wherein the resource allocation information message comprises a Downlink MAP (DL-MAP) message.

13. A system for transmitting/receiving resource allocation information in a wireless mobile communication system, the system comprising:
a transmission apparatus for allocating a data burst in a frame, wherein the data burst comprises a two-dimensional region in a time domain and a frequency domain, and for transmitting resource allocation information on the allocated data burst; and
a reception apparatus for receiving the resource allocation information from the transmission apparatus and for detecting a region of the frame where the data burst is allocated using the received resource allocation information,
wherein the resource allocation information includes information on a start point and an end point of the data burst and further wherein the start point comprises a point which is spaced apart from an start point of the frame by a first offset value in the time domain and which is spaced apart from the start point of the frame by a second offset value in the frequency domain, and the end point comprises a point which is spaced apart from the start point by a third offset value in the time domain and which is spaced apart from the start point by a fourth offset value in the frequency domain the data burst is a two-dimensional rectangular region having a diagonal line segment connecting the start point to the end point.

14. The method of claim 13, wherein the time domain comprises an Orthogonal Frequency Division Multiple Access (OFDMA) symbol domain and each of the first offset value and the third offset value comprises the number of OFDMA symbols.

15. The method of claim 13, wherein the frequency domain comprises a subchannel domain, and each of the second offset value and the fourth offset value comprises the number of subchannels.

16. The method of claim 13, wherein the resource allocation information is included in a resource allocation information message transmitted from the transmission apparatus to the reception apparatus.

17. The method of claim 16, wherein the resource allocation information message comprises a Downlink MAP (DL-MAP) message.

18. The method of claim 13, wherein each of the first offset value and the third offset value is expressed with a predetermined number of bits, and the number of bits representing each of the first offset value and the third offset value is calculated depending on at least one of a subchannel permutation method used by the transmission apparatus and the total number of OFDMA symbols included in the frame.

19. The method of claim 18, wherein the number of bits representing each of the first offset value and the third offset value is calculated using the equation
$$No . of bits for OFDMA Symbol offset = ⌈ {log}_{2} \frac{No . OFDMA Symbols }{OFDMA Symbol allocation unit} ⌉ \qquad$$
wherein No. OFDMA symbols comprises the total number of OFDMA symbols and OFDMA Symbol_allocation_unit comprises a basic allocation unit for OFDMA symbols based on the subchannel permutation method.

20. The method of claim 13, wherein each of the second offset value and the fourth offset value comprises a predetermined number of bits, and the number of bits representing each of the second offset value and the fourth offset value is calculated depending on at least one of a subchannel permutation method used by the transmission apparatus and the total number of subchannels included in the frame.

21. The method of claim 20, wherein the number of bits representing each of the second offset value and the fourth offset value is calculated using the equation
$$No . of bits for OFDMA Subchannel offset = ⌈ {log}_{2} \frac{Max No . of Subchannels }{Subchannel allocation unit} ⌉$$
wherein Max No. of Subchannels comprises the number of subchannels constituting a frame and Subchannel_allocation_unit comprises a basic allocation unit for subchannels based on the permutation method.
